(19) United States
(12) Patent Application Publication
(10) Pub. No.: US 2010/0183907 A1
(43) Pub. Date: Jul. 22, 2010

(54) Hard Spacers in Microporous Membrane Matrix

(75) Inventors: Ray L. Hauser, Boulder, CO (US); Kirby Beard, Norristown, PA (US)

Correspondence Address: Porous Power Technologies-Correspondence, Krajec Patent Offices, LLC, 820 Welch Ave, Berthoud, CO, 80513, US

(73) Assignee: POROUS POWER TECHNOLOGIES, LLC, Louisville, CO (US)

(21) Appl. No.: 12/647,366

(22) Filed: Dec. 24, 2009

Related U.S. Application Data
(60) Provisional application No. 61/140,741, filed on Dec. 24, 2008.

(51) Int. Cl. H01M 2/16

(52) U.S. Cl. 429/142

(57) ABSTRACT

A battery separator may be formed with hard spacers made from ceramic and other high temperature materials. The spacers may be incorporated into a microporous membrane so that the microporous matrix may capture and hold the spacers. The spacers may be solid or hollow glass beads that are in the range of 30% to 100% of the thickness of the separator, and may comprise less than 10 weight percent. The resulting membrane may be largely microporous, and the separators may help battery electrodes to remain physically separated, even after internal temperatures exceed the melt temperature of the separator.

### BACKGROUND

Fires in Lithium ion and other battery types can be caused by electrodes shorting during an overload condition. During an overload condition, large amounts of energy may be stored between the electrodes, and when the electrodes make direct contact, the energy may flow at a very high rate. The extremely high rate of energy flow may cause electrolyte to boil, a battery case to fail, and oxygen to enter the battery case, causing a fire. Such fires are often explosive and can cause tremendous damage.

### SUMMARY

A battery separator may be formed with hard spacers made from glass and other very high temperature materials. The spacers may be incorporated into a microporous membrane so that the microporous matrix may capture the spacers. The spacers may be solid or hollow glass beads that are in the range of 30% to 100% of the thickness of the separator, and may comprise less than 10 percent weight. The resulting membrane may be largely microporous, and the separators may help battery electrodes to remain physically separated, even after internal temperatures exceed the melt temperature of the separator.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a cross-section of porous material with spacers.

FIG. 2 is a diagram illustration of an embodiment showing a cross-section of a battery assembled with a separator having spacers.

FIG. 3 is a flowchart illustration of an embodiment showing a method for forming a porous material.

FIG. 4 is a diagram illustration of an embodiment showing a process for continuous manufacturing of porous material.

### DETAILED DESCRIPTION

Hard, insoluble dielectric materials may be incorporated into the matrix of a microporous membrane during the formation of the microporous membrane and may act as mechanical spacers within the membrane. The microporous membrane may be formed from two miscible liquids in which a polymer is dissolved. One of the liquids may be evaporated, forming the microporous structure prior to removing the second liquid. The spacers may be added to the solution prior to forming, and then may remain in the matrix after the formation process.

The membrane manufacturing process may result in a structure that has a formed polymer with many small pores and a tortuous connection from one void to another. Such a structure may be used for electrode separators for batteries, superconductors, fuel cells, and may other uses.

The membrane may be formed with relatively large spacers, such as small glass beads that may be hollow or solid. The spacers may be sized to be a large percentage of the thickness of the membrane, often from 30% to 100% of the thickness of the manufactured membrane. The spacers may be selected to survive much higher temperatures than the matrix of the microporous membrane.

The membrane may be used as an electrode separator for an electrochemical device, such as a battery, fuel cell, supercapacitor, or other similar device. The membrane may separate an anode from a cathode and may be saturated with a liquid electrolyte. Ions within the electrolyte may flow between the anode and the cathode during electrical charging and discharging.

If the electrochemical device were to be overcharged, subjected to very high temperatures, or be operated outside of its normal operating limits, the device may fail. One failure mechanism may be electrode separator failure, where the separator may become hot and melt or collapse. When operated outside normal operating limits the electrochemical device may be subjected to large pressures, which may cause electrodes to crush a separator material.

The spacers may be selected to survive such high temperatures and pressures and may keep the electrodes separated even after the separator matrix has failed. The failure of the separator matrix may render the electrochemical device useless. However, the spacers may prevent catastrophic failure such as fire or explosion by mechanically preventing electrodes from coming into direct contact and shorting. A short during an overcharged situation may cause an extremely high current density, which may cause outgassing or boiling, which may cause the device casing to fail, which may introduce oxygen into the system, which may in turn cause a fire or explosion. Such a scenario may be prevented if the electrodes are kept mechanically separated by the spacers.

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

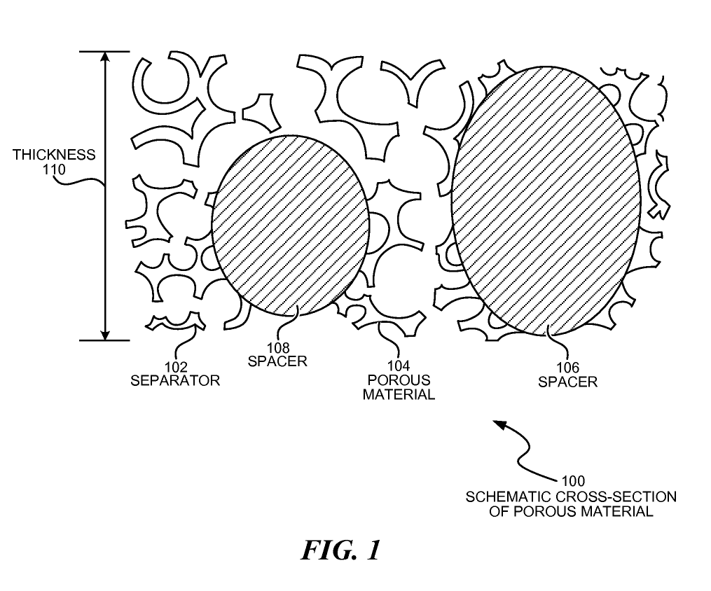

FIG. 1 is a schematic diagram of an embodiment 100 showing a cross section of a porous separator material that may be formed using a solution of a polymer dissolved in a solvent and a miscible pore forming agent that has a higher surface energy. The separator 102 comprises porous material 104 and spacers 106 and 108.

FIG. 1 is not to scale and is a schematic diagram. The separator 102 is illustrated as a matrix of porous material 104 that entraps various spacers 106 and 108. The porous material 104 may be formed by using a two-liquid solution of a polymer as described below. During the forming process, the dissolved polymer may form the porous material 104 and may capture and hold the spacers 106 and 108.

The spacers 106 and 108 may be any type of suitable material that may have a higher melting temperature of the porous material 104 and provide some structural properties. The spacers 106 and 108 may be, for example, glass beads or other type of ceramic material.

Other suitable materials for the spacers 106 and 108 may be glass, borosilicate, or other mineral chemistry. In some cases, the separators 106 and 108 may be a cross-linked polymer or copolymer such as phenolic, melamine, polyester, epoxy, or cross linked thermoplastics.

In applications such as batteries and other electrochemical devices, the separators 106 and 108 may be insulators.

The spacers 106 and 108 may have a smooth surface, and may be spherically shaped. Some spacers may be elliptical, oval, egg-shaped, or have other shapes. In many cases, the porous material 104 may be quite fragile and may easily rip. A sharp-surfaced spacer may exacerbate such a condition to the point where the separator 102 may not be easily handled.

The spacers may make up between 0.05% and 5% of the plan area of the separator 102. The plan area may be calculated by dividing the plan cross-sectional area of the spacers by the total area of the separator 102. In some embodiments, such a ratio may be as low as 0.005% and as high at 20%. Ranges of 0.1%, 1%, 2%, 3%, 4%, 5%, and 6% are often used. In some embodiments, the spacers may make up to 10% or 15% of the plan area.

The spacers 106 and 108 are incorporated into the separator 102 but may not add to the operational performance of the separator 102, except for preventing catastrophic fire or explosion in an overcharged or overheated condition. As such, the higher the spacer content in the separator, the lower the current-carrying performance of the separator. Conversely, the higher the spacer content, the more likely the electrochemical device using the separator can survive an overheated condition without causing a fire or explosion.

Spacers may be mixed into a solution prior to forming the porous material 104. In such a solution, the density (mass per unit volume) of the spacers may be selected to be close to that of the solution. When the density of the spacers is greater than the solution, the spacers may have a tendency to sink in the solution, while spacers with lower density may float. A stirring apparatus may be used to keep the spacers suspended in the solution during the forming process to compensate for the density difference between the spacers and the solution.

In some embodiments, hollow spacers may be used. For example, hollow glass beads or microballoons may be used as spacers. In many cases, such spacers may tend to float in the polymer solution and a constant stirring may keep the hollow spacers well mixed. A flotation system may be used to separate whole hollow spacers from broken spacers prior to formulation in the pore-forming solution. Whole spacers may float on the surface of a liquid while broken beads may sink.

In some embodiments, the spacers may be treated prior to use. The treatment may encourage a bond between the spacers and the polymer matrix and increase the tensile strength of the separator.

For example, glass bead spacers may be treated with silane, titanate, zirconate, or other material to improve bonding when using a polyvinylidene fluoride (PVDF) polymer for the porous material 104.

The size of the spacers may be large with respect to the thickness 110 of the separator 104. In some cases, such as spacer 106, the spacer may be 100% of the thickness of the separator 102.

The spacer size may be between 20% and 100% of the intended thickness of the separator 102. For example, the spacer size may be 25%, 30%, 40%, 50%, 60%, 70%, 75%, 80%, or 90% of the total thickness 110.

In some cases, the spacer size may be larger than the average thickness of the separator. For example, the spacers may be larger than the separator in the areas without spacers. In such cases, the spacers may be 120%, 130% or even 150% of the separator thickness in the areas without spacers.

The spacer size may not be highly uniform. Some spacers may have a high variance of sizes and may be sifted to gather spacers of a desired size.

The spacers may be colorized or otherwise treated to improve inspection mechanisms of the separator 102. For example, the spacers 106 and 108 may have a different appearance than the porous material 104 that may be visually apparent when using an automated scanning or visual processing technique.

The inspection of porous film such as embodiment 100 is often done using visual inspection mechanisms. The inspection may attempt to identify through-holes in the separator 102 which may be a defect rendering the separator unusable. Other defects may include bright spots, which may be clumps of gelled polymer that did not create porous areas. Such a defect may be usable in a battery application, for example, but may have lower performance than a properly formed separator.

Many visual inspection mechanisms may have difficulty determining the difference between holes and bright spots, and may have further difficulty differentiating between holes, bright spots, and spacers. By making the spacers a different color or providing some other contrasting mechanism, the inspection processes may be more effective.

One portion of a visual inspection process may be to determine the dispersion and coverage of the spacers within the separator 104. Ideally, the spacers would be evenly distributed throughout the separator and not have areas where no spacers are present. Visually differentiated spacers may enhance such inspection.

The spacers may enhance later assembly processes. For example, the spacers may be colorized, treated, or otherwise enhanced to be receptive to infrared radiation. Such embodiments may aid in the subsequent heat lamination of the separator 102 to another material, for example.

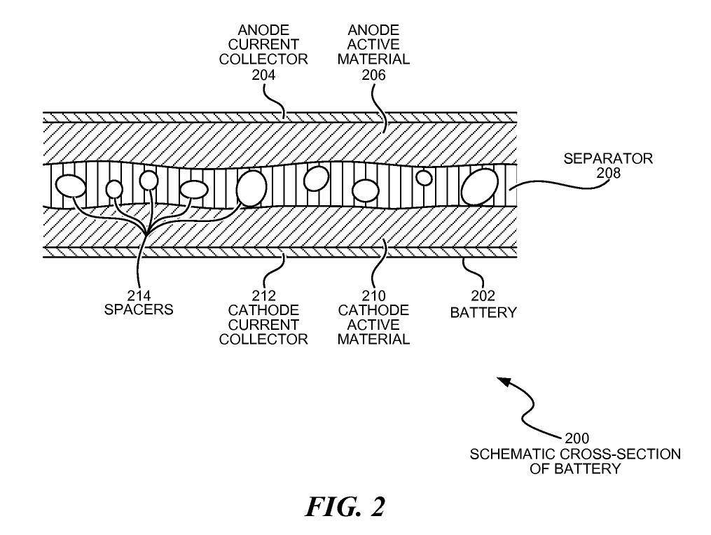

FIG. 2 is a schematic diagram of an embodiment 200 showing a cross section of an electrochemical device, such as a battery. FIG. 2 is not to scale and is merely a schematic diagram used to show some components of a battery, supercapacitor, fuel cell, or other electrochemical device that has spacers incorporated into the electrode separator.

The construction illustrated in embodiment 200 is typical of a single cell battery. An anode current collector 204 may be metallic film to which may be applied anode active material 206. A separator 208 is illustrated as separating the anode active material 206 from cathode active material 210. A cathode current collector 212 may complete the assembly.

The separator 208 is illustrated as having various spacers 214 disposed throughout the separator 208.

In normal operation, the separator 208 may contain an electrolyte and lithium ions may flow from the anode to cathode during discharging, and lithium ions may flow from the cathode to anode during charging. The electrolyte may be a liquid or paste.

If an overtemperature or overcharging condition were to occur, the separator 208 could fail by melting or mechanically collapsing. Many separator materials may be polymers that may melt at temperatures between 120 and 200 degrees Celsius. If a battery were to experience internal temperatures close to or higher than the melting temperature of the separator, the battery may be irreversibly compromised.

In an overcharging situation, the battery may contain more energy than for which it was designed. Overcharging situations can be accompanied by overheating. If the anode active material 206 were to contact the cathode active material 210, the battery may be shorted and a large amount of current flow may occur. The large amount of energy flow can cause the electrolyte to decompose, boil or off-gas, leading to very high pressures inside a battery case. The high pressures can cause the battery case to fail, introducing oxygen into the battery and causing a fire or explosion.

The spacers 214 are designed to survive a higher temperature than the separator matrix so that even if the separator matrix were to melt, the spacers 214 may prevent the anode active material 206 from contacting the cathode active material 210.

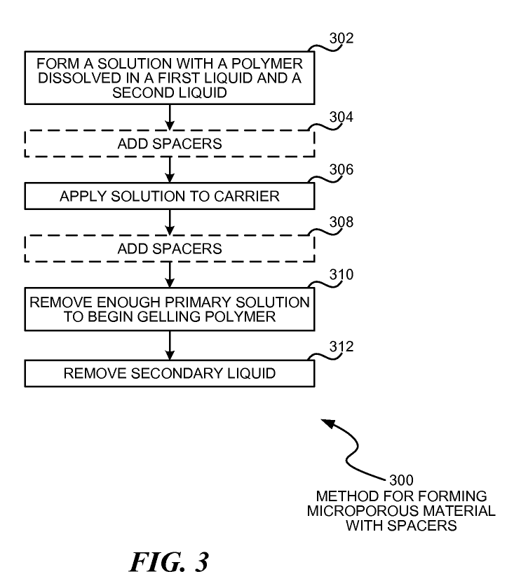

FIG. 3 is a flowchart diagram of an embodiment 300 showing a method for forming a porous material. Embodiment 300 is a general method, examples of which are discussed below.

In block 302, a solution may be formed with a polymer dissolved in a first liquid and a second liquid that may act as a pore forming agent. The liquids may be selected based on boiling points or volatility and surface tension so that when processed, the polymer is formed with a high porosity. Examples of such liquids are discussed below.

After forming the solution in block 302, spacers may be added to the solution in block 304. In some embodiments, spacers may be added to the solution at a later step.

The solution is applied to a carrier in block 306. The carrier may be any type of material and can be a prepared battery electrode. In some cases, a flat sheet of porous material may be cast onto a table top, which acts as a carrier in a batch process. In other cases, a film such as a polymer film, treated or untreated kraft paper, aluminum foil, or other backing or carrier material may be used in a continuous process.

In some cases, a porous film may be manufactured and attached to a reinforcing web, which may be incorporated into the porous matrix during formation or added as a secondary process. The reinforcing web may be a nonwoven, woven, perforated, or other reinforcing web.

The solution may be applied to the carrier by dipping, spraying, casting, extruding, pouring, spreading, or any other method of applying the solution.

If a reinforcing web is used, the reinforcing web may be any type of reinforcement, including polymer based nonwoven webs, paper products, and fiberglass. In some cases, a woven material may be used with natural or manmade fibers, while in other cases, a solid film may be perforated, slotted, or expanded and used as a reinforcing web.

In some embodiments, the spacers may be added to the applied solution in block 308.

In block 310, enough of the primary liquid may be removed so that the dissolved polymer may begin to gel. In some embodiments, some, most, or substantially all of the primary liquid may be removed in block 310. As the polymer begins to gel, the mechanical structure of the material may begin to take shape and the porosity may begin to form. During this time, the material may have some mechanical properties so that different mechanisms may be used to remove any remaining primary liquid and the secondary liquid.

The secondary liquid may be removed in block 312. During the gelling process of block 310, the differences in surface tension between the various materials may allow the secondary liquid to coalesce and form droplets, around which the polymer may gel as the first liquid is removed. After or as the polymer solidifies, the second liquid may be removed. In some cases, the boiling point or volatility of the two liquids may be selected so that the primary liquid evaporates prior to the secondary liquid.

The mechanisms for removing the primary and secondary liquids may be any type of suitable mechanism for removing a liquid. In many cases, the primary liquid may be removed by a unidirectional mass transfer mechanism such as evaporation, wicking, blotting, mechanical compression or others. Some methods may use bidirectional mass transfer such as rinsing or washing. In some cases, one method may be used to remove the primary liquid and a second method may be used for the secondary liquid. For example, the primary liquid may be at least partially removed by evaporation while the remaining primary liquid and secondary liquid may be removed by rinsing or mechanically squeezing the material.

Three embodiments are presented below of formulations and methods of production for porous material.

In a first embodiment, the porous material may be formed by first forming a layer of a polymer solution on a substrate, wherein the polymer solution may comprise two miscible liquids and a polymer material dissolved therein, wherein the two miscible liquids may comprise (i) a principal solvent liquid that may have a surface tension at least 5% lower than the surface energy of the polymer and (ii) a second liquid that may have a surface tension at least 5% greater than the surface energy of the polymer. Second, a gelled polymer may be produced from the layer of polymer solution under conditions sufficient to provide a non-wetting, high surface tension solution within the layer of polymer solution; and, thirdly, rapidly removing the liquid from the film of gelled polymer by unidirectional mass transfer without dissolving the gelled polymer to produce the strong, highly porous, microporous polymer.

In a second embodiment, the porous material may be produced using a method comprising:

(i) preparing a solution of one or more polymers in a mixture of a principal liquid which is a solvent for the polymer and a second liquid which is miscible with the principal liquid, wherein (i) the principal liquid may have a surface tension at least 5% lower than the surface energy of the polymer, (ii) the second liquid may have a surface tension at least 5% higher than the surface energy of the polymer, (iii) the normal boiling point of the principal liquid is less than 125° C. and the normal boiling point of the second liquid is less than about 160° C., (iv) the polymer may have a lower solubility in the second liquid than in the principal liquid, and (v) the solution may be prepared at a temperature less than about 20° C. above the normal boiling point of the principal liquid and while precluding any substantial evaporation of the principal liquid;

(ii) reducing the temperature of the solution by at least 5° C. to between the normal boiling point of the principal liquid and the temperature of the substrate upon the solution is to be cast;

(iii) casting the polymer solution onto a high surface energy substrate to form a liquid coating thereon, said substrate having a surface energy greater than the surface energy of the polymer; and

(iv) removing the principal liquid and the second liquid from the coating by unidirectional mass transfer without use of an extraction bath, (ii) without re-dissolving the polymer, and (iii) at a maximum air temperature of less than about 100° C. within a period of about 5 minutes, to form the strong, highly porous, thin, symmetric polymer membrane.

In a third embodiment, the porous material may be produced by a method comprising:

(i) dissolving about 3 to 20% by weight of a polymer in a heated multiple liquid system comprising (a) a principal liquid which is a solvent for the polymer and (b) a second liquid to form a polymer solution, wherein (i) the principal liquid may have a surface tension at least 5% lower than the surface energy of the polymer, (ii) the second liquid may have a surface tension at least 5% greater than the surface energy of the polymer; and (iii) the polymer may have a lower solubility in the second liquid than it has in the principal solvent liquid;

(ii) reducing the temperature of the solution by at least 5° C. to between the normal boiling point of the principal liquid and the temperature of the substrate upon which it will be cast;

(iii) casting a film of the fully dissolved solution onto a substrate which may have a higher surface energy than the surface energy of the polymer;

(iv) precipitating the polymer to form a continuous gel phase while maintaining at least 70% of the total liquid content of the initial polymer solution, said precipitation caused by a means selected from the group consisting of cooling, extended dwell time, solvent evaporation, vibration, or ultrasonics; and

(v) removing the residual liquids without causing dissolution of the continuous gel phase by unidirectional mass transfer without any extraction bath, at a maximum film temperature which is less than the normal boiling point of the lowest boiling liquid, and within a period of about 5 minutes, to form a strong, highly porous, thin, symmetric polymer membrane.

The preceding embodiments are examples of different methods by which a porous material may be formed from a liquid solution to a porous polymer. Different embodiments may be used to create porous material and such embodiments may contain additional steps or fewer steps than the embodiments described above. Other embodiments may also use different processing times, concentrations of materials, or other variations.

Each of the embodiments of porous material may begin with the formation of a solution of one or more soluble polymers in a liquid medium that comprises two or more dissimilar but miscible liquids. To form highly porous products, the total polymer concentration may generally be in the range of about 3 to 20% by weight. Lower polymer concentrations of about 3 to 10% may be preferred for the preparation of membranes having porosities greater than 70%, preferably greater than 75%, and most preferably greater than 80% by weight. Higher polymer concentrations of about 10 to 20% may be more useful to prepare slightly lower porosity membranes, i.e. about 60 to 70%.

A suitable temperature for forming the polymer solution may generally range from about 40° C. up to about 20° above the normal boiling point of the principal liquid, preferably about 40 to 80° C., more preferably about 50° C. to about 70° C. A suitable pressure for forming the polymer solution may generally range from about 0 to about 50 psig. In some embodiments, the polymer solution may be formed in a vacuum. Preferably a sealed pressurized system is used.

The porous material may be formed in the presence of at least two dissimilar but miscible liquids to form the polymer solution from which a polymer film may be cast. The first “principal” liquid may be a better solvent for the polymer than the second liquid and may have a surface tension at least 5%, preferably at least 10%, lower than the surface energy of the polymer involved. The second liquid may be a solvent or a non-solvent for the polymer and may have a surface tension at least 5%, preferably at least 10%, greater than the surface energy of the polymer.

The principal liquid may be at least 70%, preferably about 80 to 95%, by weight of the total liquid medium. The principal liquid may dissolve the polymer at the temperature and pressure at which the solution may be formed. The dissolution may generally take place near or above the boiling temperature of the principal liquid, usually in a sealed container to prevent evaporation of the principal liquid. The principal liquid may have a greater solvent strength for the polymer than the second liquid. Also, the principal liquid may have a surface tension at least about 5%, preferably at least about 10%, lower than the surface energy of the polymer. The lower surface tension may lead to better polymer wetting and greater solubilizing power.

The second liquid, which may generally represent about 1 to 10% by weight of the total liquid medium, may be miscible with the first liquid. The second liquid may or may not dissolve the polymer as well as the first liquid at the selected temperature and pressure. The second liquid may have a higher surface tension than the surface energy of the polymer. Preferably, the second liquid may or may not wet the polymer at the gelation temperature though it may wet the polymer at more elevated temperatures.

Table A and Table B identify some specific principal and second liquids that may be used with typical polymers, especially including PVDF. Table A lists liquids that have at least some degree of solubility towards PVDF (surface energy of 35 dyne/cm), which may produce the dissolved polymer solution in the first step of the process. Ideally, a liquid may be selected from Table A that has solubility limits between 1% and 50% by weight of polymer at a temperature within the range of about 20 and 90° C. The liquids in Table B, on the other hand, may have lower polymer solubility than those in Table A, but may be selected because they have a higher surface tension than both the principal liquid and the polymers that may be dissolved in the solution made with liquid(s) from Table A.

Tables A and B represent typical examples of suitable liquids that may be used to create a porous material. Other embodiments may use different liquids as a principal liquid or second liquid.

Examples of suitable liquids for use as the principal liquid, along with their boiling point and surface tensions are provided in Table A below. The table is arranged in order of increasing boiling point, which is a useful parameter for achieving rapid gelling and removal of the liquid during the film formation step. In some applications, a lower boiling point may be preferred.

TABLE A

| | | Surface |
|---|---|---|
| | Normal Boiling | Energy, |
| Principal Liquid | Point, EC | dynes/cm |
| methyl formate | 31.7 | 24.4 |
| acetone (2-propanone) | 56 | 23.5 |
| methyl acetate | 56.9 | 24.7 |
| Tetrahydrofuran | 66 | 26.4 |
| ethyl acetate | 77 | 23.4 |
| methyl ethyl ketone | 80 | 24 |
| (2-butanone) | | |
| Acetonitrile | 81 | 29 |
| dimethyl carbonate | 90 | 31.9 |
| 1,2-dioxane | 100 | 32 |
| Toluene | 110 | 28.4 |
| methyl isobutyl ketone | 116 | 23.4 |

Examples of suitable liquids for use as the second liquid, along with their boiling point and surface tensions are provided in Table B below. This table is arranged in order of increasing surface tension as higher surface tension may result in optimum pore size distributions during the gelling and liquid removal steps of the process.

TABLE B

| | Normal boiling | Surface Energy, |
|---|---|---|
| Second Liquid | point, ° C. | dynes/cm |
| nitromethane | 101 | 37 |
| bromobenzene | 156 | 37 |
| formic acid | 100 | 38 |
| pyridine | 114 | 38 |
| ethylene bromide | 131 | 38 |
| 3-furaldehyde | 144 | 40 |
| bromine | 59 | 42 |
| tribromomethane | 150 | 42 |
| quinoline | 24 | 43 |
| nitric acid (69%) | 86 | 43 |
| water | 100 | 72.5 |

The porous material may be formed by using a liquid medium for forming the polymer solution. The liquid medium may be rapidly removable at a sufficiently low temperature so that the second liquid may be removed without re-dissolving the polymer during the liquid removal process. The liquid medium may or may not be devoid of plasticizers. The liquids that form the liquid medium may be relatively low boiling point materials. In many embodiments, the liquids may boil at temperatures less than about 125° C., preferably about 100° C. and below. Somewhat higher boiling point liquids, i.e. up to about 160° C., may be used as the second liquid if at least about 60% of the total liquid medium is removable at low temperature, e.g. less than about 50° C. The balance of the liquid medium can be removed at a higher temperature and/or under reduced pressure. Suitable removal conditions depend upon the specific liquids, polymers, and concentrations utilized.

Preferably the liquid removal may be completed within a short period of time, e.g. less than 5 minutes, preferably within about 2 minutes, and most preferably within about 1.5 minutes. Rapid low temperature liquid removal, preferably using air flowing at a temperature of about 80° C. and below, most preferably at about 60° C. and below, without immersion of the membrane into another liquid, has been found to produce a membrane with enhanced uniformity. The liquid removal may be done in a tunnel oven with an opportunity to remove and/or recover flammable, toxic or expensive liquids. The tunnel oven temperature may be operated at a temperature less than about 90° C., preferably less than about 60° C. in some sections and up to 110° C. or more in other sections.

The polymer solution may become supersaturated in the process of film formation. Generally cooling of the solution will cause the supersaturation. Alternatively, the solution may become supersaturated after film formation by means of evaporation of a portion of the principal liquid. In each of these cases, a polymer gel may be formed while there is still sufficient liquid present to generate the desired high void content in the resulting polymer film when that remaining liquid is subsequently removed.

After the polymer solution has been prepared, it may then be formed into a thin film. The film-forming temperature may be preferably lower than the solution-forming temperature. The film-forming temperature may be sufficiently low that a polymer gel may rapidly form. That gel may then be stable throughout the liquid removal procedure. A lower film-forming temperature may be accomplished, for example, by pre-cooling the substrate onto which the solution is deposited, or by self-cooling of the polymer solution by controlled evaporation of the principal liquid.

The film-forming step may occur at a lower temperature (and often at a lower pressure) than the solution-forming step. Commonly, it may occur at or about room temperature. However, it may occur at any temperature and pressure if the gelation of the polymer is caused by means other than cooling, such as by slight drying, extended dwell time, vibrations, or the like. Application as a thin film may allow the polymer to gel in a geometry defined by the interaction of the liquids of the solution.

The thin film may be formed by any suitable means. Extrusion or flow through a controlled orifice or by flow through a doctor blade may be commonly used. The substrate onto which the solution may be deposited may have a surface energy higher than the surface energy of the polymer. Examples of suitable substrate materials (with their surface energies) include copper (44 dynes/cm), aluminum (45 dynes/cm), glass (47 dynes/cm), polyethylene terephthalate (44.7 dynes/cm), and nylon (46 dynes/cm). In some cases a metal, metalized, or glass surface may be used. More preferably the metalized surface is an aluminized polyalkylene such as aluminized polyethylene and aluminized polypropylene.

In view of the thinness of the films, the temperature throughout may be relatively uniform, though the outer surface may be slightly cooler than the inner layer. Thermal uniformity may enable the subsequent polymer precipitation to occur in a more uniform manner.

The films may be cooled or dried in a manner that prevents coiling of the polymer chains. Thus the cooling/drying may be conducted rapidly, i.e. within about 5 minutes, preferably within about 3 minutes, most preferably within about 2 minutes, because a rapid solidification of the spread polymer solution facilitates retention of the partially uncoiled orientation of the polymer molecules when first deposited from the polymer solution.

The process may entail producing a film of gelled polymer from the layer of polymer solution under conditions sufficient to provide a non-wetting, high surface tension solution within the layer of polymer solution. Preferably gelation of the polymer into a continuous gel phase occurs while maintaining at least 70% of the total liquid content of the initial polymer solution. More particularly, the precipitation of the gelled polymer is caused by a means selected from a group consisting of cooling, extended dwell time, solvent evaporation, vibration, or ultrasonics. Then, the balance of the liquids may be removed by a unidirectional process, usually by evaporation, from the formed film to form a strong micro-porous membrane of geometry controlled by the combination of the two liquids in the medium. In some embodiments, a liquid bath may be used to extract the liquids from the membrane. In other embodiments, the liquid materials may evaporate at moderate temperatures, i.e. at a temperature lower than that used for the polymer dissolution to prepare the polymer solution. The reduced temperature may be accomplished by the use of cool air or even the use of forced convection with cool to slightly warmed air to promote greater evaporative cooling.

The interaction among the two liquids (with their different surface tension characteristics) and the polymer (with a surface energy intermediate the surface tensions of the liquids) may yield a membrane with high porosity and relatively uniform pore size throughout its thickness. The surface tension forces may act at the interface between the liquids and the polymer to give uniformity to the cell structure during the removal step. The resulting product may be a solid polymeric membrane with relatively high porosity and uniformity of pore size. The strength of the membrane in some embodiments may be surprisingly high, due to the more linear orientation of polymer molecules.

The ratio of the principal liquid to the second liquid at the point of gelation may be adjusted such that the surface tension of the composite liquid phase may be greater than the surface energy of the polymer. The calculation of the composite liquid surface tension can be predicted based upon the mol fractions of liquids, as defined in “Surface Tension Prediction for Liquid Mixtures,” AIChE Journal, vol 44, no. 10, p. 2324, 1998, the subject matter of which is incorporated herein by reference. The calculation is noted in Reid, Prausnitz, and Sherwood The Properties of Gases and Liquids, 3d Ed, McGraw Hill Book Company p. 621.

Thermodynamic calculations show that adiabatic cooling of a solution can be significant initially and that the temperature gradient through such a film is very small. The latter may be considered responsible for the exceptional uniformity obtained using these methods.

The polymers used to produce the microporous membranes of the present invention may be organic polymers. Accordingly, the microporous polymers comprise carbon and a chemical group selected from hydrogen, halogen, oxygen, nitrogen, sulfur and a combination thereof. In a preferred embodiment, the composition of the microporous polymer may include a halogen. Preferably, the halogen is selected from the group consisting of chloride, fluoride, and a mixture thereof.

Suitable polymers for use herein may be include semi-crystalline or a blend of at least one amorphous polymer and at least one crystalline polymer.

Preferred semi-crystalline polymers may be selected from the group consisting of polyvinylidene fluoride, polyvinylidene fluoride-hexafluoropropylene copolymer, polyvinyl chloride, polyvinylidene chloride, chlorinated polyvinyl chloride, polymethyl methacrylate, polyamide, polyaramide, polyamide-imide, and mixtures of two or more of these semi-crystalline polymers.

In some embodiments, the products produced by the processes described herein may be used as a battery separator. For this use, the polymer may comprise a polymer selected from the group consisting of polyvinylidene fluoride (PVDF), polylvinylidene fluoride-hexafluoropropylene copolymer (PVDF-HFP), polyvinyl chloride, and mixtures thereof. Still more preferably the polymer may comprise at least about 75% polyvinylidene fluoride.

The “MacMullin” or “McMullin” Number measures resistance to ion flow is defined in U.S. Pat. No. 4,464,238, the subject matter of which is incorporated herein by reference. The MacMullin Number is “a measure of resistance to movement of ions. The product of MacMullin Number and thickness defines an equivalent path length for ionic transport through the separator. The MacMullin Number appears explicitly in the one-dimensional dilute solution flux equations which govern the movement of ionic species within the separator; it is of practical utility because of the ease with which it is determined experimentally.” The lower a MacMullin Number the better for battery separators, the better. Products using these techniques may have a low MacMullin number, i.e. about 1.05 to 3, preferably about 1.05 to less than 2, most preferably about 1.05 to about 1.8.

Good tortuosity is an additional attribute of some embodiments. A devious or tortuous flow path with multiple interruptions and fine pores may act as a filter against penetration of invading solids. Tortuosity of the flow path can be helpful to prevent penetration by loose particles from an electrode or to minimize growth of dendrites through a separator that might cause electrical shorts. This characteristic cannot be quantified, except by long-term use, but it can be observed qualitatively by viewing a cross-section of the porosity.

Some embodiments may be generally uniform and symmetric, i.e. the substrate side pores may be substantially similar in size to the central and the air side pores. Pores varying in diameter by a factor of about 5 or less may be sufficiently uniform for the membranes to function in a symmetric manner.

Where additional strength or stiffness may be needed for handling purposes, micro- or nano-particles can be added to the formulation with such particulates residing within the polymer phase. A few such additives include silica aerogel, talc, and clay.

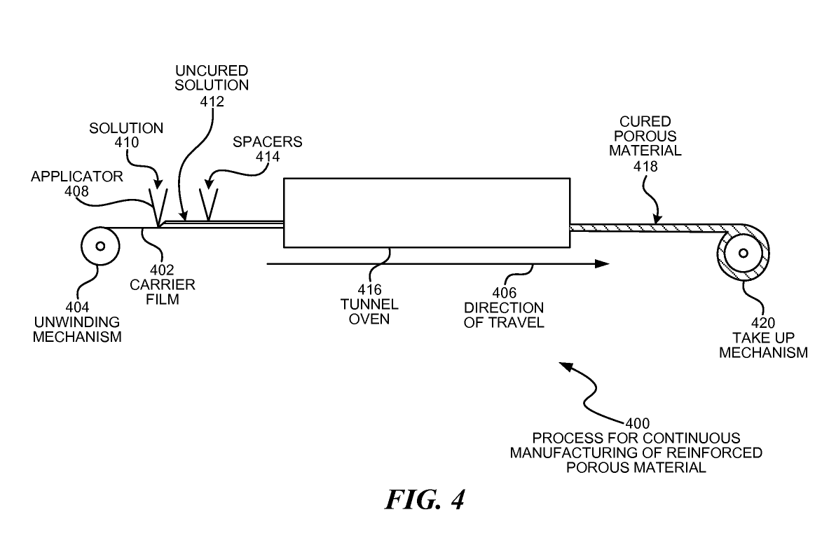

FIG. 4 is a diagram illustration of an embodiment 400 showing a process for continuous manufacturing of porous material. Embodiment 400 is an example of a general process that may be used to form porous material directly on a carrier film. Other embodiments may include a reinforced web, such as a nonwoven web, woven web, or perforated film or electrode material.

A carrier film 402 may be unwound with an unwinding mechanism 404 and moved in the direction of travel 406. Various carrier films may be used.

As the carrier film 402 is being moved in the direction 406, solution 410 may be applied to the carrier file 402 with an applicator 408. The applicator 408 may apply a wet solution 410 to form an uncured solution 412.

In some embodiments, spacers may be included in the solution 410 and applied with the dissolved polymer in a single application step. In other embodiments, a separate applicator may add spacers 414 to the applied uncured solution 412 prior to entering the tunnel oven 416.

The carrier film 402 may be used to facilitate handling of the web and may provide a bottom surface against which the liquid solution 412 may be supported while in the uncured state. Such carrier material may include treated kraft paper, various polymeric films, metal films, metalized carriers, or other material. Some embodiments may use a carrier material in subsequent manufacturing steps and may include the carrier material with the cured porous material 418 on the take-up mechanism 420. In other embodiments, the carrier material may be stripped from the cured porous material 418 before the take up mechanism 420. In still other embodiments, a continuous recirculating belt or screen may be used beneath the carrier film 402 during processing.

The embodiment 400 illustrates a manufacturing sequence that may be predominantly horizontal. In other embodiments, a vertical manufacturing process may have a direction of travel in either vertical direction, either up or down. A vertical direction of travel may enable a porous material to evenly form on two sides of a reinforcement web or an electrode material. Such an embodiment may have an applicator system that may apply solution to both sides of a reinforcement web.

The applicator 408 may be any mechanism by which the solution 410 may be applied to the carrier film 402. In some embodiments, the solution 410 may be continuously cast, sprayed, extruded, or otherwise applied. Some embodiments may use a slot die, doctor blade, or other mechanism to distribute the solution 410.

The thickness of the resulting reinforced porous material may be adjusted by controlling the amount of solution 410 that is applied to the carrier film 402 and the speed of the web during application, among other variables.

Some embodiments may includes various additional processes, such as air knives, calendering, rolling, or other processing before, during, or after the solution 410 has formed into a solid porous polymer material.

The uncured solution 412 may be transferred through a tunnel oven 416 or other processes in order to form a cured porous material 418, which may be taken up with a take-up mechanism 420.

The tunnel oven 416 may have different zones for applying various temperature profiles to the uncured solution 412 in order to form a porous material. In many cases, an initial lower temperature may be used to evaporate a portion of a primary liquid and begin formation of a solid polymer structure. A higher temperature may be used to remove a second liquid and remaining primary liquid.

In some embodiments, the tunnel oven 416 may provide air transfer using heated or cooled air to facilitate curing.

Embodiment 400 is an example of a continuous process for manufacturing a porous material by forming the porous material by introducing a wet solution directly onto a continuous web of carrier film 402. Other embodiments may include casting a porous material directly onto a reinforced web in a batch mode, such as casting on non-moving table surface.

Several experiments have been performed to examine the characteristics of separator bead incorporated into battery separator material manufactured by the above methods.

Experiments DD144 in Example 3 and DD146A used a treatment of Lord AP-134 on glass beads in a diluted concentration. Lord technical data indicate that coatings of this product on glass are generally in the region of 1.5 to 2.5 microns in thickness. The tensile strength of membrane from DD144 was an average of 2870 KPa, considerably better than DD135 which was 1820. This coupling treatment is confirmed to be a silane.

Hollow beads can present a weakness if any of the beads are broken during processing. Shards or pieces of broken ceramic beads cause sharp edges and stress concentrations, weakening the microporous membrane. Experiments have shown that floated glass beads (they float because they are unbroken) give about 33% higher strength in the microporous membranes than beads that are not selectively floated.

Solid ceramic spheres are preferred to hollow glass beads if none are broken.

If a silane coating with density 1.1 g/cc is applied to glass beads at a thickness of 1.0 microns, the increased weight and diameter of the average bead comes out to be 0.86 g/cc, very close to the density of the PVDF solution used for casting these microporous membranes.

Beads (hollow, solid or microporous) are appropriate in the range of 0.2 to 10 volume percent of polymer solids, preferably in the range of 0.5 to 3 volume percent, giving area coverage ranging from 3 to 10 percent. The beads are of diameter 20 to 100% that of the intended membrane thickness, preferably of diameter 40 to 80%.

The following calculations are involved in these descriptions:

Area of 1 gram of PVDF at 25 micron thickness, 80% porosity=1/(1.76 gm/cc)(0.0025 cm thick)=227 sq.cm. Cross-sectional area of a single 3 M bead of 18-micron diameter is 3.1416×(9×9) square microns.

Cross-sectional area of 1 gram of beads in monolayer=3.14(9×9) microns 10⁻⁸ cm²/micron²/1831×10⁻¹² grams/bead=1387 sq.cm. Weight of bead is calculated from its density of 0.6 grams/cc times the volume, which is 4/3(3.14)9³ microns³=1831×10⁻¹² gram. The solid glass density (2.23 gm/cc), bead density (0.6 gm/cc) permits calculation of an average inside diameter, which is 8.11 microns. Weight/bead is 1831×10⁻¹² grams.

Area fraction of beads, A, is weight concentration, C phr× 1387/227. Spacing is (254/A)^{0.5}.

### Example 1

### DD#60, S80

A solution of polyvinylidene fluoride was made at 6% weight concentration with 91.5% acetone and 3.5% water. 0.27 phr (parts per hundred resin, by weight) of hollow glass beads were added to the PVDF. The glass beads had been pre-sifted through a 325-mesh screen to obtain particles less than 25 microns diameter. Density of individual beads was not known. The solution was heated to about 50° C. to accomplish dissolution of the polymer, it was cooled to about 40° C. and was cast onto a pre-treated polyester film with wet-film thickness about 200 microns. Upon cooling and drying, the polymer formed a microporous membrane about 25 microns thick, having porosity of 78% and having air flow permeation of 30 cm/minute torr (volume/area×time×pressure differential). Air flow through a membrane sample is an indicator of ionic flow when the membrane is placed within a battery, hence is an indirect measure of current density.

### Example 2

### DD#63, S83

A solution was prepared as in Example 1 but with addition of 0.3 phr of hollow phenolic beads. The cast membrane had thickness about 25 microns, porosity 76% and air flow permeation of 20 cm/minute torr.

### Example 3

### 3M #iM30K Hollow Glass Beads

Solutions were prepared as in Example 1 but with the addition of hollow glass beads, 3M #iM30K having average diameter of 18 microns, true density 0.60 grams/cc and isostatic crushing strength 28,000 psi. The beads were added at concentrations of 0.5, 1.0, and 2.0 phr. Membranes were cast onto treated polyester film at a wet-film thickness about 200 microns. Upon cooling and drying the polymer formed microporous membranes as follows:

| | Concentration | | Average square | | | Air flow |
|---|---|---|---|---|---|---|
| DD | of beads, phr | Area conc. | spacing between | Thickness, of | Porosity, of | through membrane, |
| # | by weight | of beads, % | beads, microns | membrane, microns | membrane % | cm/min · torr |
| 133 | 0.2 | 1.2 | 145 | 25 | 76 | 13 |
| 134 | 0.5 | 3. | 91 | 27 | 77 | 9.5 |
| 135 | 1.0 | 6.1 | 64 | 28 | 76 | 12.1 |
| 143 | 2.0 | 12.2 | 46 | 28 | 73 | 5.3 |
| 144 | 1.0 treated | 6.1 | 64 | 28 | 74 | 6.6 |
| | with silane, | | | | | |
| | floated | | | | | |

The area concentration of beads and the average spacing between beads are calculated here assuming a monolayer of the beads and a membrane thickness of 25 microns. Any stacking of beads would give a lower area concentration and a larger spacing between such stacks.

### Example 4

### Solid Glass Beads

Solutions were prepared as in Example 1, but with the addition of solid glass beads having glass density 2.5 gm/cc. These beads were obtained from Mo-Sci Specialty Products, LLC of Rolla, Mo., grade Gl-0191, 13-22 micron diameter. The beads were added to give a volume concentration fairly comparable to that of DD 135 and DD144 in Example 3. Membranes were cast onto treated polyester film at a wet-film thickness about 200 microns. Upon cooling and drying, the polymer formed microporous membranes as follows:

| | Concentration | | Average square | | | Air flow |
|---|---|---|---|---|---|---|
| DD | of beads, phr | Area conc. | spacing between | Thickness, of | Porosity, of | through membrane, |
| # | by weight | of beads, % | beads, microns | membrane, microns | membrane % | cm/min · torr |
| 150 | 4.2 | 6.1 | 64 | 27 | 68 | 3.7 |

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. An electrode separator manufactured from a method comprising:
forming a solution with a dissolved polymer in a first liquid and a second liquid, said solution comprising spacer beads having a spacer melting temperature higher than a polymer melting temperature of said dissolved polymer;
applying said solution to a carrier;
removing enough of said first liquid to begin gelling said polymer; and
after said gelling has begun, removing said second liquid to form a film having a final thickness.

2. The electrode separator of claim 1, said spacer beads having an average diameter greater than 30% of said final thickness.

3. The electrode separator of claim 2, said spacer beads having a maximum size of 125% of said final thickness.

4. The electrode separator of claim 2, said spacer beads comprising glass beads.

5. The electrode separator of claim 4, said spacer beads being treated with a coupling agent prior to being added to said solution.

6. The electrode separator of claim 2, said spacer beads being hollow beads.

7. The electrode separator of claim 2, said spacer beads being solid beads.

8. The electrode separator of claim 2, said spacer beads comprising a high temperature polymer.

9. The electrode separator of claim 7, said high temperature polymer comprising a cross-linked polymer.

10. The electrode separator of claim 2, said dissolved polymer being a polyvinylidene fluoride.

11. The electrode separator of claim 10 further comprising:
a reinforcing web.

12. A battery comprising:
an anode current collector;
an anode active material;
a cathode current collector;
a cathode active material; and
a separator disposed between said anode active material and said cathode active material, said separator comprising a microporous polymer and a plurality of separator beads, said separator beads having a higher melting temperature than said microporous polymer.

13. The battery of claim 12 further comprising an electrolyte disposed in said separator.

14. The battery of claim 13, said electrolyte being a liquid.

15. The battery of claim 13, said electrolyte being a paste.

16. The battery of claim 12, said separator beads comprising no more than 5% of a plan area of said separator.

17. The battery of claim 12, said separator beads comprising at least 1% of a plan area of said separator.
